(19) United States
(12) Patent Application Publication
(10) Pub. No.: US 2015/0187296 A1
(43) Pub. Date: Jul. 2, 2015

(54) METHOD OF DRIVING A DISPLAY PANEL, DISPLAY PANEL DRIVING APPARATUS FOR PERFORMING THE METHOD AND DISPLAY APPARATUS HAVING THE DISPLAY PANEL DRIVING APPARATUS

(71) Applicant: Samsung Display Co., Ltd., Yongin-city (KR)

(72) Inventors: Sang-Hun LEE, Seoul (KR); Seong-Hyun GO, Yongin-si (KR); Young-Ju KIM, Incheon (KR); Jun-Yong AHN, Seoul (KR); Jeong-Oh JIN, Seoul (KR)

(21) Appl. No.: 14/522,275

(22) Filed: Oct. 23, 2014

(30) Foreign Application Priority Data
Dec. 30, 2013 (KR) 10-2013-0166785

(51) Int. Cl. G09G 3/36

(52) U.S. Cl. CPC G09G 3/3614; G09G 3/3677; G09G 3/3648

(57) ABSTRACT

A method of driving a display panel includes sequentially driving a first gate line and a second gate line of a display panel during an N-th frame to charge data signals to first row pixels electrically connected to the first gate line and the second gate line, sequentially driving a third gate line and a fourth gate line of the display panel during the N-th frame to charge the data signals to second row pixels electrically connected to the third gate line and the fourth gate line, sequentially driving the second gate line and the first gate line during an (N+1)-th frame to charge the data signals to the first row pixels, and sequentially driving the fourth gate line and the third gate line during the (N+1)-th frame to charge the data signals to the second row pixels. Thus, display quality of a display apparatus may be improved.

### PRIORITY STATEMENT

This application claims priority from and the benefit of Korean Patent Application No. 10-2013-0166785, filed on Dec. 30, 2013, which is hereby incorporated by reference for all purposes as if fully set forth herein.

### BACKGROUND

1. Field

Exemplary embodiments of the present inventive concept relate to a method of driving a display panel, a display panel driving apparatus for performing the method and display apparatus having the display panel driving apparatus. More particularly, exemplary embodiments of the present inventive concept relate to a method of driving a display panel including a gate line and a data line, a display panel driving apparatus for performing the method and display apparatus having the display panel driving apparatus.

2. Discussion of the Background

A liquid crystal display apparatus includes a liquid crystal display panel, a gate driving part, a data driving part and a timing controlling part.

The liquid crystal display panel includes a lower substrate including a thin film transistor and a pixel electrode, an upper substrate including a common electrode, and a liquid crystal layer interposed between the lower substrate and the upper substrate and including a liquid crystal of which alignment is changed by an electric field between a pixel voltage applied to the pixel electrode and a common voltage applied to the common electrode.

In addition, the liquid crystal display panel includes a plurality of gate lines extending in a first direction, a plurality of data lines extending in a second direction substantially perpendicular to the first direction, and a plurality of pixels defined by the gate lines and the data lines.

Data signals having different polarities may be charged to the pixels so as to prevent deterioration of the liquid crystal. For example, the polarities of the data signals may be inverted per two pixels in the first direction and the polarities of the data signals may be inverted per one pixel in the second direction.

In this case, when a polarity of a data signal charged to a previously driven pixel and a polarity of a data signal charged to a presently driven pixel are substantially the same, a charge ratio of the data signal charged to the presently driven pixel is not decreased. In contrast, when the polarity of the data signal charged to the previously driven pixel and the polarity of the data signal charged to the presently driven pixel are not substantially the same, the charge ratio of the data signal charged to the presently driven pixel is decreased.

For example, in a unit pixel including a red pixel, a green pixel and a blue pixel, a charge ratio of the red pixel and a charge ratio of the blue pixel may be comparatively low and a charge ratio of the green pixel may be comparatively high. Therefore, a charge ratio of the pixel is not uniform, and thus display quality of a display apparatus is decreased.

The above information disclosed in this Background section is only for enhancement of understanding of the background of the invention and therefore it may contain information that does not form any part of the prior art nor what the prior art may suggest to a person of ordinary skill in the art.

### SUMMARY OF THE INVENTIVE CONCEPT

Exemplary embodiments of the present inventive concept provide a method of driving a display panel capable of improving display quality.

Exemplary embodiments of the present inventive concept provide a display panel driving apparatus for performing the above-mentioned method.

Exemplary embodiments of the present inventive concept also provide a display apparatus having the above-mentioned display panel driving apparatus.

Additional features of the invention will be set forth in the description which follows, and in part will be apparent from the description, or may be learned by practice of the invention.

An exemplary embodiment of the present inventive concept provides a method of driving a display panel includes sequentially driving a first gate line and a second gate line of a display panel during an N-th frame to charge data signals to first row pixels electrically connected to the first gate line and the second gate line, sequentially driving a third gate line and a fourth gate line of the display panel during the N-th frame to charge the data signals to second row pixels electrically connected to the third gate line and the fourth gate line, sequentially driving the second gate line and the first gate line during an (N+1)-th frame next to the N-th frame to charge the data signals to the first row pixels, and sequentially driving the fourth gate line and the third gate line during the (N+1)-th frame to charge the data signals to the second row pixels.

An exemplary embodiment of the present inventive concept provides a display panel driving apparatus that includes a gate driver and a data driver. The gate driver is configured to sequentially drive a first gate line and a second gate line of a display panel during an N-th frame, configured to sequentially drive a third gate line and a fourth gate line of the display panel during the N-th frame, configured to sequentially drive the second gate line and the first gate line during an (N+1)-th frame next to the N-th frame, and configured to drive the fourth gate line and the third gate line during the (N+1)-th frame. The data driver is configured to charge data signals to first row pixels electrically connected to the first gate line and the second gate line during the N-th frame, configured to charge the data signals to second row pixels electrically connected to the third gate line and the fourth gate line, configured to charge the data signals to the first row pixels during the (N+1)-th frame, and configured to charge the data signals to the second row pixels during the (N+1)-th frame.

An exemplary embodiment of the present inventive concept also provides a display apparatus that includes a display panel and a display panel driving apparatus. The display panel is configured to display an image. The display panel driving apparatus includes a gate driver configured to sequentially drive a first gate line and a second gate line of the display panel during an N-th frame, configured to sequentially drive a third gate line and a fourth gate line of the display panel during the N-th frame, configured to sequentially drive the second gate line and the first gate line during an (N+1)-th frame next to the N-th frame and configured to drive the fourth gate line and the third gate line during the (N+1)-th frame, and a data driver configured to charge data signals to first row pixels electrically connected to the first gate line and the second gate line during the N-th frame, configured to charge the data signals to second row pixels electrically connected to the third gate line and the fourth gate line, configured to charge the data signals to the first row pixels during the (N+1)-th frame and configured to charge the data signals to the second row pixels during the (N+1)-th frame.

According to the present inventive concept, charge ratios of pixels are uniform of substantially uniform, and therefore display quality of the display apparatus may be improved.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

The above and other features and advantages of the present inventive concept will become more apparent by describing in detailed example embodiments thereof with reference to the accompanying drawings.

FIG. 1 is a block diagram illustrating a display apparatus according to an exemplary embodiment of the present inventive concept.

FIG. 2 is a plan view illustrating a display panel of FIG. 1.

FIG. 3A is a timing diagram illustrating a gate start signal, a first gate clock signal, and a second gate clock signal of FIG. 1 during an N-th frame.

FIG. 3B is a timing diagram illustrating the gate start signal, the first gate clock signal, and the second gate clock signal of FIG. 1 during an (N+1)-th frame.

FIG. 4A is a plan view illustrating the display panel of FIG. 1 during the N-th frame.

FIG. 4B is a plan view illustrating the display panel of FIG. 1 during the (N+1)-th frame.

FIG. 5A is a waveform diagram illustrating a red data signal, a green data signal, the red data signal, and the green data signal respectively charged to a first red pixel, a first green pixel, a third red pixel, and a third green pixel of FIG. 2 during the N-th frame.

FIG. 5B is a waveform diagram illustrating the red data signal, a blue data signal, the red data signal, and the blue data signal respectively charged to a second red pixel, a first blue pixel, a fourth red pixel, and a third blue pixel of FIG. 2 during the N-th frame.

FIG. 5C is a waveform diagram illustrating the blue data signal, the green data signal, the blue data signal, and the green data signal respectively charged to a second blue pixel, a second green pixel, a fourth blue pixel, and a fourth green pixel of FIG. 2 during the N-th frame.

FIG. 6A is a waveform diagram illustrating the green data signal, the red data signal, the green data signal, and the red data signal respectively charged to the first green pixel, the first red pixel, the third green pixel, and the third red pixel of FIG. 2 during the (N+1)-th frame.

FIG. 6B is a waveform diagram illustrating the blue data signal, the red data signal, the blue data signal, and the red data signal respectively charged to the first blue pixel, the second red pixel, the third blue pixel, and the fourth red pixel of FIG. 2 during the (N+1)-th frame.

FIG. 6C is a waveform diagram illustrating the green data signal, the blue data signal, the green data signal, and the blue data signal respectively charged to the second green pixel, the second blue pixel, the fourth green pixel, and the fourth blue pixel of FIG. 2 during the (N+1)-th frame.

FIGS. 7A, 7B, 7C, 7D and 7E are flow charts illustrating an exemplary embodiment of a method of driving the display panel driving apparatus of FIG. 1.

### DETAILED DESCRIPTION OF THE INVENTIVE CONCEPT

Hereinafter, the present inventive concept will be explained in detail with reference to the accompanying drawings.

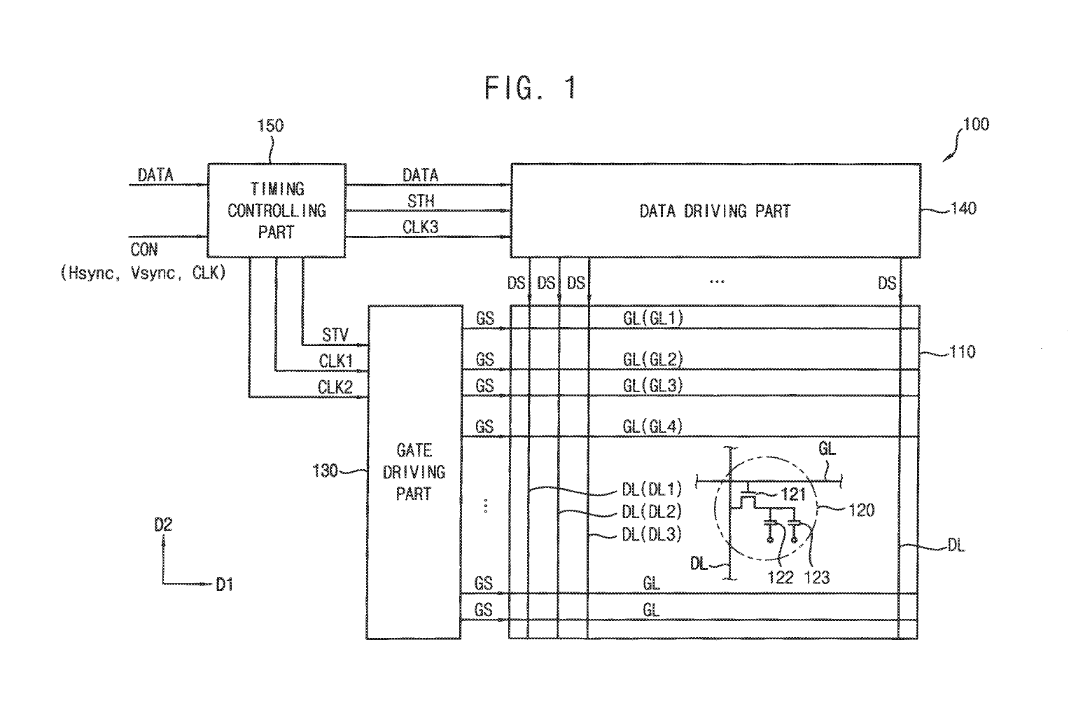

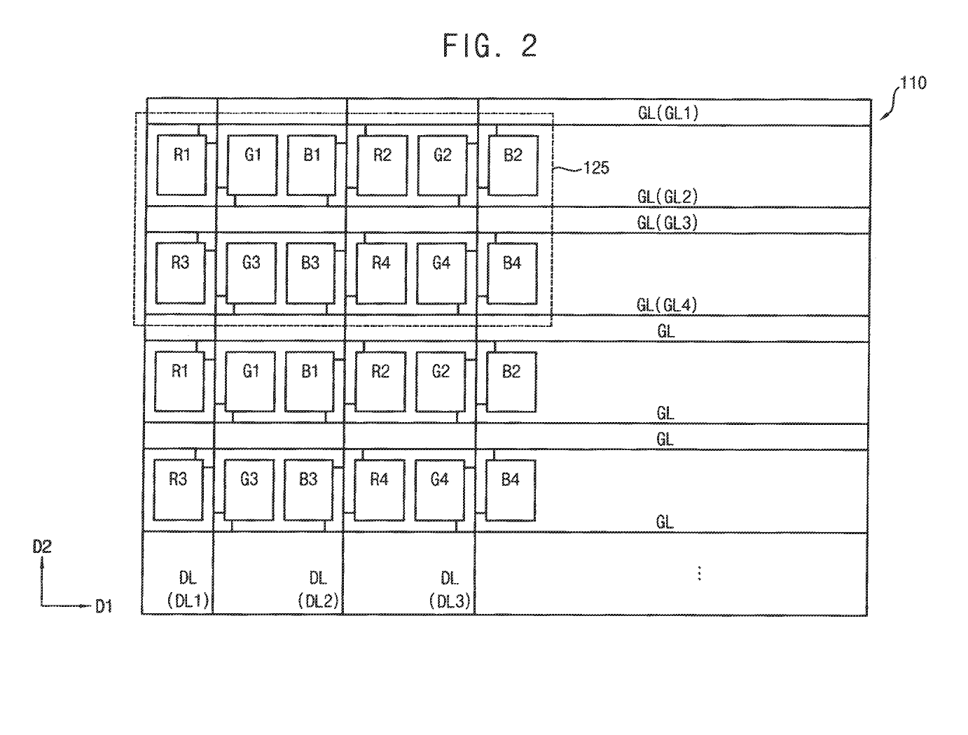

FIG. 1 is a block diagram illustrating a display apparatus according to an exemplary embodiment of the present inventive concept. FIG. 2 is a plan view illustrating the display panel 110 of FIG. 1.

Referring to FIGS. 1 and 2, the display apparatus 100 according to the present exemplary embodiment includes a display panel 110, a gate driving part or gate driver 130, a data driving part or data driver 140 and a timing controlling part or timing controller 150.

The display panel 110 receives a data signal DS based on an image data DATA provided from the timing controlling part 150 to display an image. For example, the image data DATA may be two-dimensional plane image data. The image data DATA may include a left-eye image data and a right-eye image data for displaying a three-dimensional stereoscopic image.

The display panel 110 includes gate lines GL including a first gate line GL1, a second gate line GL2, a third gate line GL3 and a fourth gate line GL4, data lines DL including a first data line DL1, a second data line DL2 and a third data line DL3, and a plurality of pixels 120. The gate line GL extends in a first direction D1 and the data line DL extends in a second direction D2 substantially perpendicular to the first direction D1; however, aspects need not be limited thereto such that the first direction D1 and the second direction D2 need not be substantially perpendicular and may be disposed to cross at a lessor or greater angle. Each of the pixels 120 includes a thin film transistor 121 electrically connected to the gate line GL and the data line DL, a liquid crystal capacitor 122 and a storage capacitor 123 connected to the thin film transistor 121.

The display panel 110 includes a first red pixel R1, a first green pixel G1, a first blue pixel B1, a second red pixel R2, a second green pixel G2, a second blue pixel B2, a third red pixel R3, a third green pixel G3, a third blue pixel B3, a fourth red pixel R4, a fourth green pixel G4 and a fourth blue pixel B4.

The first red pixel R1, the first green pixel G1, the first blue pixel B1, the second red pixel R2, the second green pixel G2 and the second blue pixel B2 are disposed between the first gate line GL1 and the second gate line GL2. Thus, the first red pixel R1, the first green pixel G1, the first blue pixel B1, the second red pixel R2, the second green pixel G2 and the second blue pixel B2 are disposed at a first row of the display panel 110, and may be defined as first row pixels.

The third red pixel R3, the third green pixel G3, the third blue pixel B3, the fourth red pixel R4, the fourth green pixel G4 and the fourth blue pixel B4 are disposed between the third gate line GL3 and the fourth gate line GL4. Thus, the third red pixel R3, the third green pixel G3, the third blue pixel B3, the fourth red pixel R4, the fourth green pixel G4 and the fourth blue pixel B4 are disposed at a second row of the display panel 110, and may be defined as second row pixels.

The first red pixel R1 is electrically connected to the first gate line GL1 and the first data line DL1. The first green pixel G1 is electrically connected to the second gate line GL2 and the first data line DL1. The first blue pixel B1 is electrically connected to the second gate line GL2 and the second data line DL2. The second red pixel R2 is electrically connected to the first gate line GL1 and the second data line DL2. The second green pixel G2 is electrically connected to the second gate line GL2 and the third data line DL3. The second blue pixel B2 is electrically connected to the first gate line GL1 and the third data line DL3.

The third red pixel R3 is electrically connected to the third gate line GL3 and the first data line DL1. The third green pixel G3 is electrically connected the fourth gate ling GL4 and the first data line DL1. The third blue pixel B3 is electrically connected to the fourth gate line GL4 and the second data line DL2. The fourth red pixel R4 is electrically connected to the third gate line GL3 and the second data line DL2. The forth green pixel G4 is electrically connected to the fourth gate line GL4 and the third data line DL3. The fourth blue pixel B4 is electrically connected to the third gate line GL3 and the third data line DL3

The first red pixel R1, the first green pixel G1, the first blue pixel B1, the second red pixel R2, the second green pixel G2, the second blue pixel B2, the third red pixel R3, the third green pixel G3, the third blue pixel B3, the fourth red pixel R4, the fourth green pixel G4 and the fourth blue pixel B4 may be defined as a unit pixel 125. The unit pixel 125 repeats in the first direction D1 and the second direction D2.

The gate driving part 130 generates a gate signal GS in response to a gate start signal STV, a first gate clock signal CLK1 and a second gate clock signal CLK2 provided from the timing controlling part 150, and outputs the gate signal GS to the gate line GL. Specifically, the gate driving part 130 outputs the gate signals GS to odd-numbered gate lines including the first gate line GL1 and the third gate line GL3 in response to an activation of the first gate clock signal CLK1. In addition, the gate driving part 130 outputs the gate signals GS to even-numbered gate lines including the second gate line GL2 and the fourth gate line GL4 in response to an activation of the second gate clock signal CLK2. The gate driving part 130 may be disposed outside of the display panel 110. Alternatively, the gate driving part 130 may be disposed on the display panel 110. For example, the gate driving part 130 may be an amorphous silicon gate (ASG).

The data driving part 140 outputs the data signal DS to the data line DL in response to a data start signal STH and a data clock signal CLK3 provided from the timing controlling part 150. The data driving part 140 outputs data signals DS of which polarities are different to adjacent data lines DL. For example, the data driving part 140 may output data signals having positive polarities to odd-numbered data lines including the first data line DL1 and the third data line DL3, and may output data signals having negative polarities to even-numbered data lines including the second data line DL2.

In addition, the data driving part 140 inverts the polarities of the data signals DS every two horizontal periods. For example, the data signal DS having the positive polarity may be charged to the first red pixel R1 and the first green pixel G1, the data signal DS having the negative polarity may be charged to the first blue pixel B1 and the second red pixel R2, the data signal DS having the positive polarity may be charged to the second green pixel G2 and the second blue pixel B2, the data signal DS having the negative polarity may be charged to the third red pixel R3 and the third green pixel G3, the data signal DS having the positive polarity may be charged to the third blue pixel B3 and the fourth red pixel R4, and the data signal DS having the negative polarity may be charged to the fourth green pixel G4 and the fourth blue pixel B4.

Therefore, the pixels 120 are inverted per two dots in the first direction D1 and inverted per one dot in the second direction D2. Thus, the display panel 110 is driven 2*1 dot inversion method.

The timing controlling part 150 receives the image data DATA and a control signal CON. The control signal CON may include a horizontal synchronous signal Hsync, a vertical synchronous signal Vsync, and a clock signal CLK. The timing controlling part 150 generates the data start signal STH using the horizontal synchronous signal Hsync and outputs the data start signal STH to the data driving part 140. The timing controlling part 150 generates the gate start signal STV using the vertical synchronous signal Vsync and outputs the gate start signal STV to the gate driving part 130. The timing controlling part 150 also generates the first gate clock signal CLK1, the second gate clock signal CLK2, and the data clock signal CLK3 using the clock signal CLK, and outputs the first gate clock signal CLK1 and the second gate clock signal CLK2 to the gate driving part 130 and outputs the data clock signal CLK3 to the data driving part 140.

The timing controlling part 150 changes an output sequence of the first gate clock signal CLK1 and the second gate clock signal CLK2 each frame. For example, during each odd-numbered frame, the timing controlling part 150 may sequentially output the first gate clock signal CLK1 and the second gate clock signal CLK2, and during each even-numbered frame the timing controlling part 150 may sequentially output the second gate clock signal CLK2 and the first gate clock signal CLK1.

The gate driving part 130, the data driving part 140 and the timing controlling part 150 may be defined as a display panel driving apparatus driving the display panel 110.

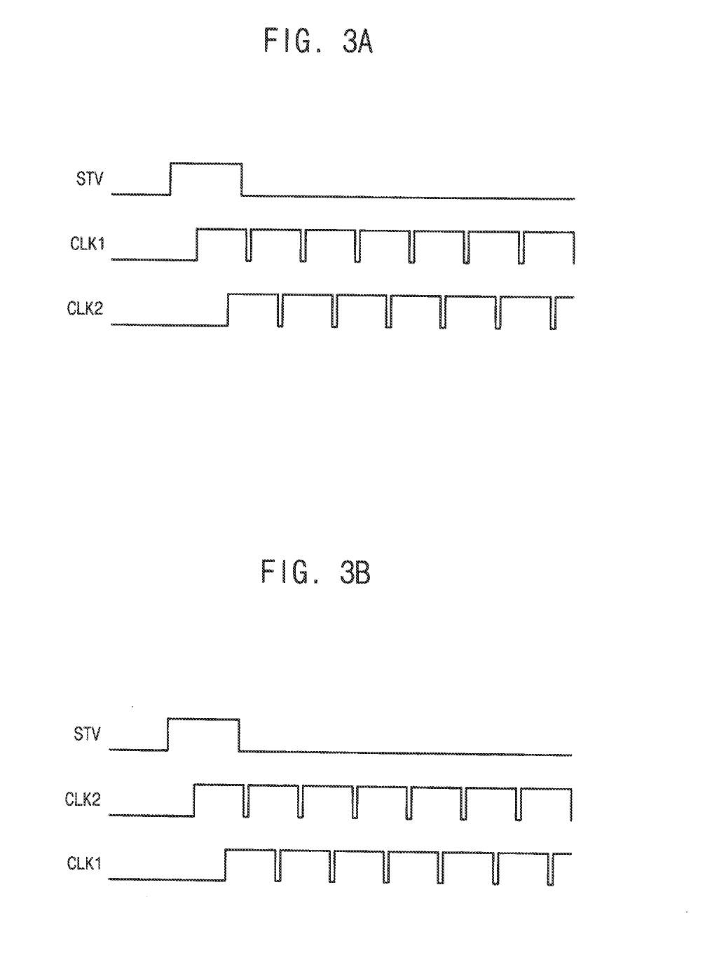

FIG. 3A is a timing diagram illustrating the gate start signal STV, the first gate clock signal CLK1, and the second gate clock signal CLK2 of FIG. 1 during the N-th frame, and FIG. 3B is a timing diagram illustrating the gate start signal STV, the first gate clock signal CLK1, and the second gate clock signal CLK2 of FIG. 1 during the (N+1)-th frame.

Referring to FIGS. 1, 2, 3A, and 3B, during the N-th frame, the first gate clock signal CLK1 and the second gate clock signal CLK2 are sequentially outputted in response to the gate start signal STV. The N-th frame may be one of the odd-numbered frames. In addition, during the (N+1)-th frame, the second gate clock signal CLK2 and the first gate clock signal CLK1 are sequentially outputted in response to the gate start signal STV. The (N+1)-th frame may be one of the even-numbered frames Although the N-th frame and (N+1)-th frame are described as odd and even-numbered frames, respectively, aspects need not be limited thereto such that the N-th frame and (N+1)-th frame may be even and odd-numbered frames, respectively.

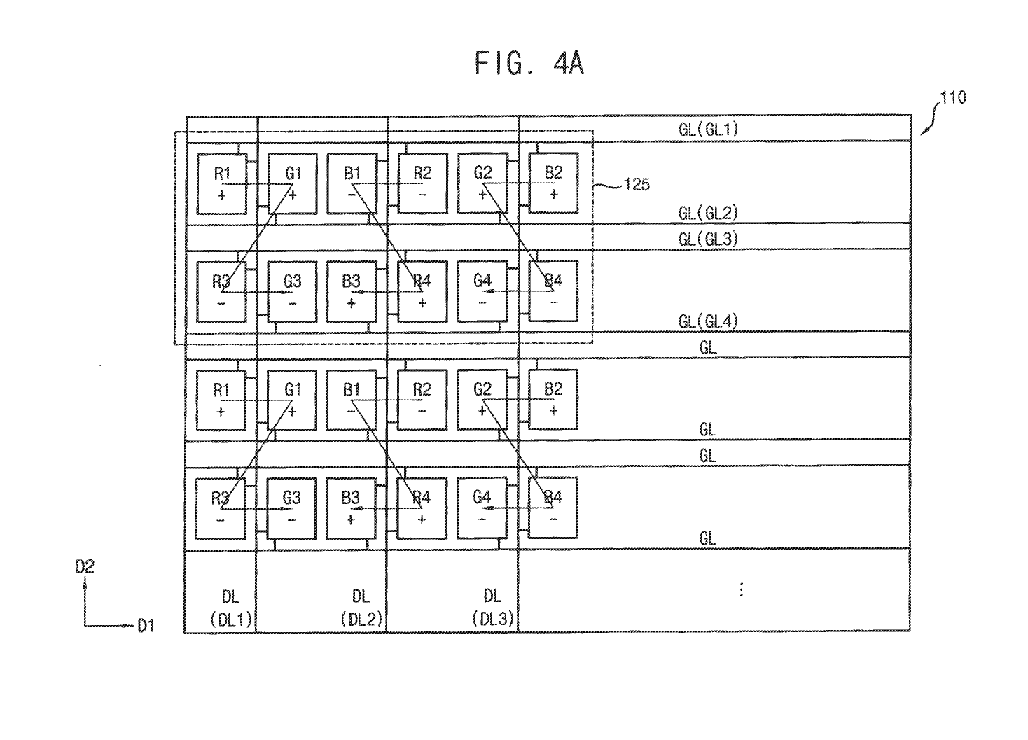

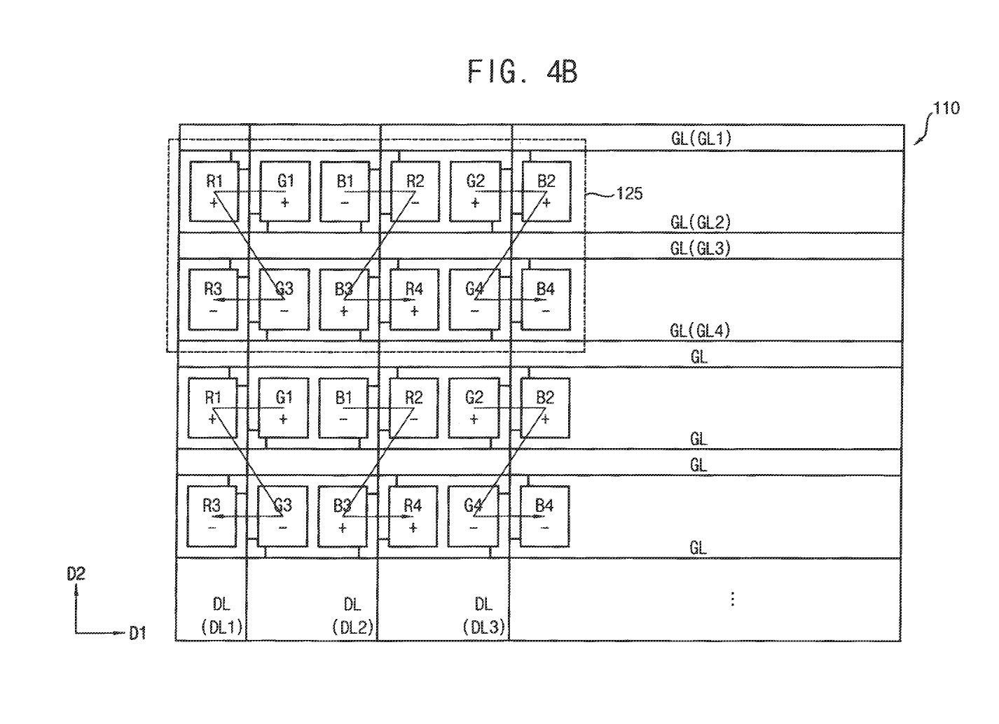

FIG. 4A is a plan view illustrating the display panel 110 of FIG. 1 during the N-th frame, and FIG. 4B is a plan view illustrating the display panel 110 of FIG. 1 during the (N+1)-th frame.

Referring to FIG. 4A, the first gate clock signal CLK1 and the second gate clock signal CLK2 are sequentially outputted during the N-th frame, therefore the first gate line GL1, the second gate line GL2, the third gate line GL3, and the fourth gate line GL4 are sequentially driven. Accordingly, the first red pixel R1, the first green pixel G1, the third red pixel R3, and the third green pixel G3 are sequentially driven. In the similar way, the second red pixel R2, the first blue pixel B1, the fourth red pixel R4, and the third blue pixel B3 are sequentially driven, and the second blue pixel B2, the second green pixel G2, the fourth blue pixel B4, and the fourth green pixel G4 are sequentially driven.

Referring to FIG. 4B, the second gate clock signal CLK2 and the first gate clock signal CLK1 are sequentially outputted during the (N+1)-th frame, the second gate line, the first gate line GL1, the fourth gate line GL4, and the third gate line GL3 are sequentially driven. Accordingly, the first green pixel G1, the first red pixel R1, the third green pixel G3, and the third red pixel R3 are sequentially driven. In the similar way, the first blue pixel B1, the second red pixel R2, the third blue pixel B3, and the fourth red pixel R4 are sequentially driven, and the second green pixel G2, the second blue pixel B2, the fourth green pixel G4, and the fourth blue pixel B4 are sequentially driven.

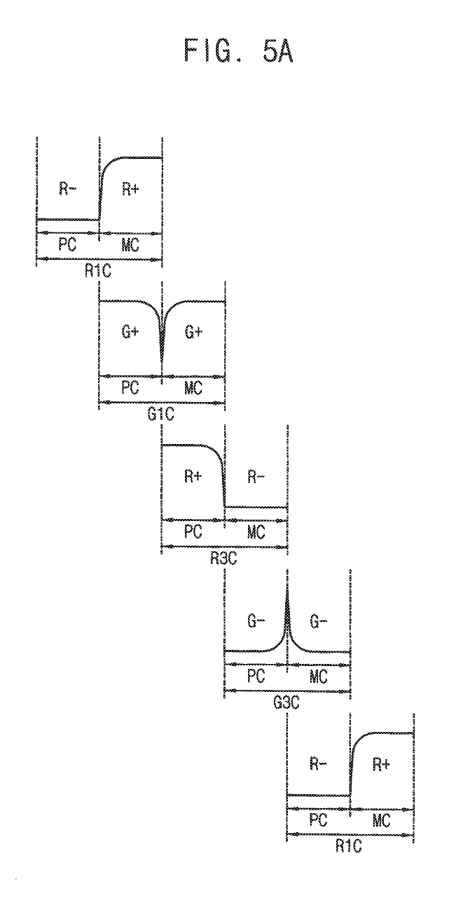

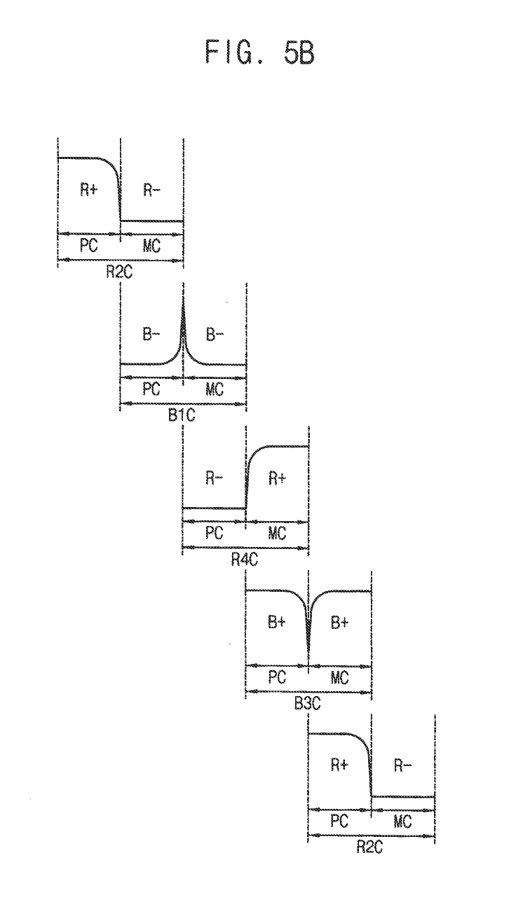

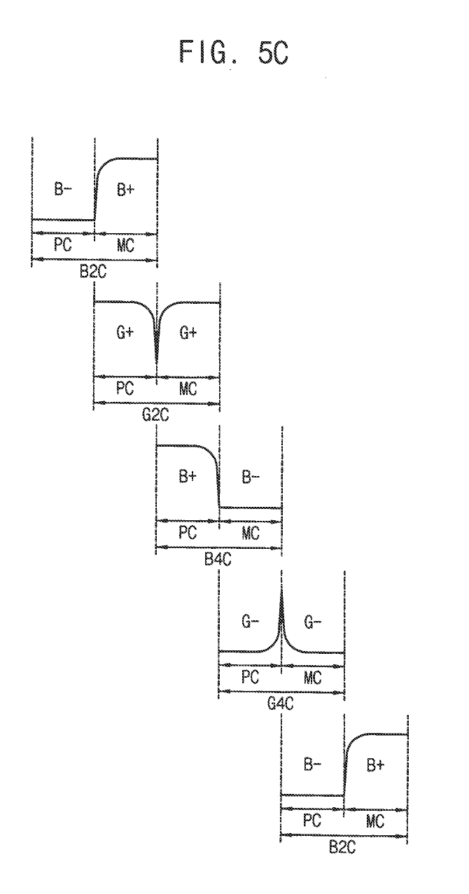

FIG. 5A is a waveform diagram illustrating a red data signal, a green data signal, the red data signal, and the green data signal respectively charged to the first red pixel R1, the first green pixel G1, the third red pixel R3, and the third green pixel G3 of FIG. 2 during the N-th frame.

Referring to FIGS. 2, 3A, 4A, and 5A, a first red pixel charge period R1C during which the first red pixel R1 is charged includes a pre-charge period PC and a main-charge period MC. The pre-charge period PC of the first red pixel charge period R1C and a main-charge period MC of a third green pixel charge period G3C during which the third green pixel G3 is charged are overlapped. A negative red signal R− is charged to the first red pixel R1 during the pre-charge period PC of the first red pixel charge period R1C corresponding to a negative green signal G− charged to the third green pixel G3 during the main-charge period MC of the third green pixel charge period G3C. A positive red signal R+ is charged to the first red pixel R1 during the main-charge period MC of the first red pixel charge period R1C. The negative red signal R− and the positive red signal R+ having different polarities are charged to the first red pixel R1, therefore a charge ratio of the first red pixel R1 is comparatively low.

A first green pixel charge period G1C during which the first green pixel G1 is charged includes a pre-charge period PC and a main-charge period MC. The pre-charge period PC of the first green pixel charge period G1C and the main-charge period MC of the first red pixel charge period R1C are overlapped. A positive green signal G+ is charged to the first green pixel G1 during the pre-charge period PC of the first green pixel charge period G1C corresponding to the positive red signal R+ charged to the first red pixel R1 during the main-charge period MC of the first red pixel charge period R1C. The positive green signal G+ is charged to the first green pixel G1 during the main-charge period MC of the first green pixel charge period G1C. The positive green signals G+ having substantially the same polarities are charged to the first green pixel G1, therefore a charge ratio of the first green pixel G1 is comparatively high.

A third red pixel charge period R3C during which the third red pixel R3 is charged includes a pre-charge period PC and a main-charge period MC. The pre-charge period PC of the third red pixel charge period R3C and the main-charge period MC of the first green pixel charge period G1C are overlapped. The positive red signal R+ is charged to the third red pixel R3 during the pre-charge period PC of the third red pixel charge period R3C corresponding to the positive green signal G+ charged to the first green pixel G1 during the main-charge period MC of the first green pixel charge period G1C. The negative red signal R− is charged to the third red pixel R3 during the main-charge period MC of the third red pixel charge period R3C. The positive red signal R+ and the negative red signal R− having different polarities are charged to the third red pixel R3, therefore a charge ratio of the third red pixel R3 is comparatively low.

The third green pixel charge period G3C during which the third green pixel G3 is charged includes a pre-charge period PC and the main-charge period MC. The pre-charge period PC of the third green pixel charge period G3C and the main-charge period MC of the third red pixel charge period R3C are overlapped. The negative green signal G− is charged to the third green pixel G3 during the pre-charge period PC of the third green pixel charge period G3C corresponding to the negative red signal R− charged to the third red pixel R3 during the main-charge period MC of the third red pixel charge period R3C. The negative green signal G− is charged to the third green pixel G3 during the main-charge period MC of the third green pixel charge period G3C. The negative green signals G− having substantially the same polarities are charged to the third green pixel G3, therefore a charge ratio of the third green pixel G3 is comparatively high.

FIG. 5B is a waveform diagram illustrating the red data signal, a blue data signal, the red data signal, and the blue data signal respectively charged to the second red pixel R2, the first blue pixel B1, the fourth red pixel R4, and the third blue pixel B3 of FIG. 2 during the N-th frame.

Referring to FIGS. 2, 3A, 4A, and 5B, a second red pixel charge period R2C during which the second red pixel R2 is charged includes a pre-charge period PC and a main-charge period MC. The pre-charge period PC of the second red pixel charge period R2C and a main-charge period MC of a third blue pixel charge period B3C during which the third blue pixel B3 is charged are overlapped. The positive red signal R+ is charged to the second red pixel R2 during the pre-charge period PC of the second red pixel charge period R2C corresponding to a positive blue signal B+ charged to the third blue pixel B3 during the main-charge period MC of the third blue pixel charge period B3C. The negative red signal R− is charged to the second red pixel R2 during the main-charge period MC of the second red pixel charge period R2C. The positive red signal R+ and the negative red signal R− having different polarities are charged to the second red pixel R2, therefore a charge ratio of the second red pixel R2 is comparatively low.

A first blue pixel charge period B1C during which the first blue pixel B1 is charged includes a pre-charge period PC and a main-charge period MC. The pre-charge period PC of the first blue pixel charge period B1C and the main-charge period MC of the second red pixel charge period R2C are overlapped. A negative blue signal B− is charged to the first blue pixel B1 during the pre-charge period PC of the first blue pixel charge period B1C corresponding to the negative red signal R− charged to the second red pixel R2 during the main-charge period MC of the second red pixel charge period R2C. The negative blue signal B− is charged to the first blue pixel B1 during the main-charge period MC of the first blue pixel charge period B1C. The negative blue signals B− having substantially the same polarities are charged to the first blue pixel B1, therefore a charge ratio of the first blue pixel B1 is comparatively high.

A fourth red pixel charge period R4C during which the fourth red pixel R4 is charged includes a pre-charge period PC and a main-charge period MC. The pre-charge period PC of the fourth red pixel charge period R4C and the main-charge period MC of the first blue pixel charge period B1C are overlapped. The negative red signal R− is charged to the fourth red pixel R4 during the pre-charge period PC of the fourth red pixel charge period R4C corresponding to the negative blue signal B− charged to the first blue pixel B1 during the main-charge period MC of the first blue pixel charge period B1C. The positive red signal R+ is charged to the fourth red pixel R4 during the main-charge period MC of the fourth red pixel charge period R4C. The negative red signal R− and the positive red signal R+ having different polarities are charged to the fourth red pixel R4, therefore a charge ratio of the fourth red pixel R4 is comparatively low.

The third blue pixel charge period B3C during which the third blue pixel B3 is charged includes a pre-charge period PC and the main-charge period MC. The pre-charge period PC of the third blue pixel charge period B3C and the main-charge period MC of the fourth red pixel charge period R4C are overlapped. The positive blue signal B+ is charged to the third blue pixel B3 during the pre-charge period PC of the third blue pixel charge period B3C corresponding to the positive red signal R+ charged to the fourth red pixel R4 during the main-charge period MC of the fourth red pixel charge period R4C. The positive blue signal B+ is charged to the third blue pixel B3 during the main-charge period MC of the third blue pixel charge period B3C. The positive blue signals B+ having substantially the same polarities are charged to the third blue pixel B3, therefore a charge ratio of the third blue pixel B3 is comparatively high.

FIG. 5C is a waveform diagram illustrating the blue data signal, the green data signal, the blue data signal, and the green data signal respectively charged to the second blue pixel B2, the second green pixel G2, the fourth blue pixel B4, and the fourth green pixel G4 of FIG. 2 during the N-th frame.

Referring to FIGS. 2, 3A, 4A, and 5C, a second blue pixel charge period B2C during which the second blue pixel B2 is charged includes a pre-charge period PC and a main-charge period MC. The pre-charge period PC of the second blue pixel charge period B2C and a main-charge period MC of a fourth green pixel charge period G4C during which the fourth green pixel G4 is charged are overlapped. The negative blue signal B− is charged to the second blue pixel B2 during the pre-charge period PC of the second blue pixel charge period B2C corresponding to the negative green signal G− charged to the fourth green pixel G4 during the main-charge period MC of the fourth green pixel charge period G4C. The positive blue signal B+ is charged to the second blue pixel B2 during the main-charge period MC of the second blue pixel charge period B2C. The negative blue signal B− and the positive blue signal B+ having different polarities are charged to the second blue pixel B2, therefore a charge ratio of the second blue pixel B2 is comparatively low.

A second green pixel charge period G2C during which the second green pixel G2 is charged includes a pre-charge period PC and a main-charge period MC. The pre-charge period PC of the second green pixel charge period G2C and the main-charge period MC of the second blue pixel charge period B2C are overlapped. The positive green signal G+ is charged to the second green pixel G2 during the pre-charge period PC of the second green pixel charge period G2C corresponding to the positive blue signal B+ charged to the second blue pixel B2 during the main-charge period MC of the second blue pixel charge period B2C. The positive green signal G+ is charged to the second green pixel G2 during the main-charge period MC of the second green pixel charge period G2C. The positive green signals G+ having substantially the same polarities are charged to the second green pixel G2, therefore a charge ratio of the second green pixel G2 is comparatively high.

A fourth blue pixel charge period B4C during which the fourth blue pixel B4 is charged includes a pre-charge period PC and a main-charge period MC. The pre-charge period PC of the fourth blue pixel charge period B4C and the main-charge period MC of the second green pixel charge period G2C are overlapped. The positive blue signal B+ is charged to the fourth blue pixel B4 during the pre-charge period PC of the fourth blue pixel charge period B4C corresponding to the negative green signal G+ charged to the second green pixel G2 during the main-charge period MC of the second green pixel charge period G2C. The negative blue signal B− is charged to the fourth blue pixel B4 during the main-charge period MC of the fourth blue pixel charge period B4C. The positive blue signal B+ and the negative blue signal B− having different polarities are charged to the fourth blue pixel B4, therefore a charge ratio of the fourth blue pixel B4 is comparatively low.

The fourth green pixel charge period G4C during which the fourth green pixel G4 is charged includes a pre-charge period PC and the main-charge period MC. The pre-charge period PC of the fourth green pixel charge period G4C and the main-charge period MC of the fourth blue pixel charge period B4C are overlapped. The negative green signal G− is charged to the fourth green pixel G4 during the pre-charge period PC of the fourth green pixel charge period G4C corresponding to the negative blue signal B− charged to the fourth blue pixel B4 during the main-charge period MC of the fourth blue pixel charge period B4C. The negative green signal G− is charged to the fourth green pixel G4 during the main-charge period MC of the fourth green pixel charge period G4C. The negative green signals G− having substantially the same polarities are charged to the fourth green pixel G4, therefore a charge ratio of the fourth green pixel G4 is comparatively high.

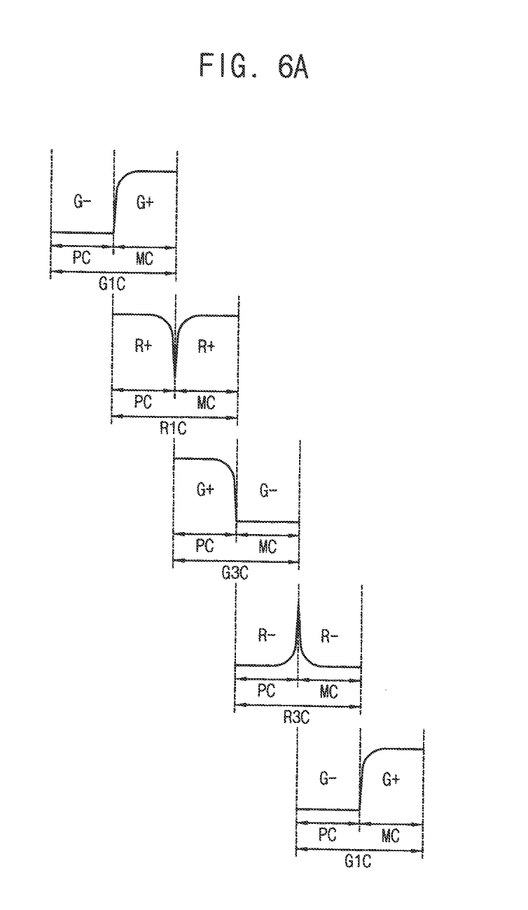

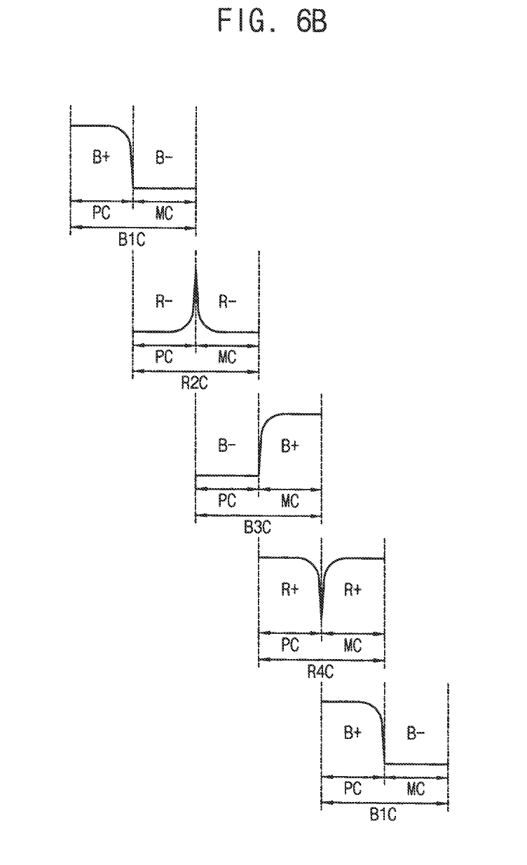

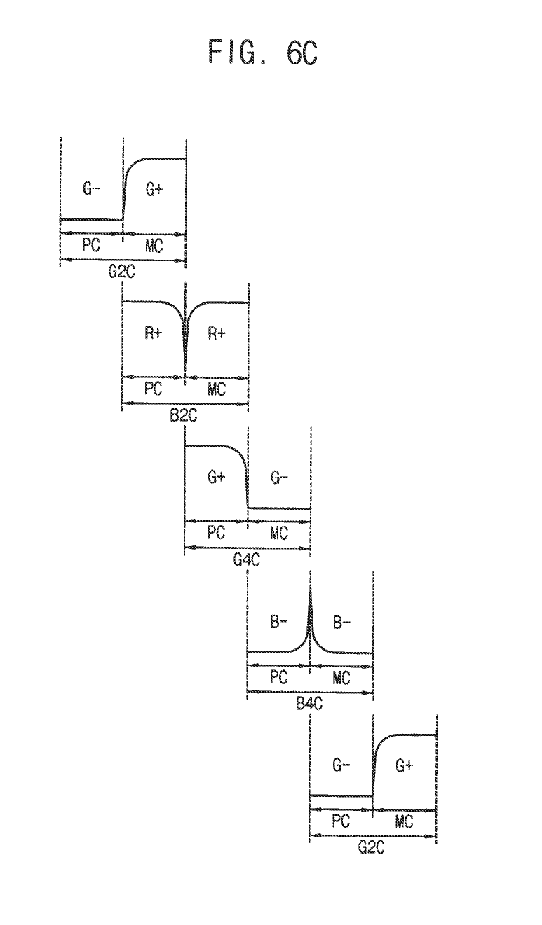

FIG. 6A is a waveform diagram illustrating the green data signal, the red data signal, the green data signal, and the red data signal respectively charged to the first green pixel G1, the first red pixel R1, the third green pixel G3, and the third red pixel R3 of FIG. 2 during the (N+1)-th frame.

Referring to FIGS. 2, 3B, 4B, and 6A, the pre-charge period PC of the first green pixel charge period G1C and the main-charge period PC of the third red pixel charge period R3C are overlapped. The negative green signal G− is charged to the first green pixel G1 during the pre-charge period PC of the first green pixel charge period G1C corresponding to the negative red signal R− charged to the third red pixel R3 during the main-charge period MC of the third red pixel charge period R3C. The positive green signal G+ is charged to the first green pixel G1 during the main-charge period MC of the first green pixel charge period G1C. The negative green signal G− and the positive green signal G+ having different polarities are charged to the first green pixel G1, therefore the charge ratio of the first green pixel G1 is comparatively low.

The pre-charge period PC of the first red pixel charge period R1C and the main-charge period PC of the first green pixel charge period G1C are overlapped. The positive red signal R+ is charged to the first red pixel R1 during the pre-charge period PC of the first red pixel charge period R1C corresponding to the positive green signal G− charged to the first green pixel G1 during the main-charge period MC of the first green pixel charge period G1C. The positive red signal R+ is charged to the first red pixel R1 during the main-charge period MC of the first red pixel charge period R1C. The positive red signals R+ having substantially the same polarities are charged to the first red pixel R1, therefore the charge ratio of the first red pixel R1 is comparatively high.

The pre-charge period PC of the third green pixel charge period G3C and the main-charge period PC of the first red pixel charge period R1C are overlapped. The positive green signal G+ is charged to the third green pixel G3 during the pre-charge period PC of the third green pixel charge period G3C corresponding to the positive red signal R+ charged to the first red pixel R1 during the main-charge period MC of the first red pixel charge period R1C. The negative green signal G− is charged to the third green pixel G3 during the main-charge period MC of the third green pixel charge period G3C. The positive green signal G+ and the negative green signal G− having different polarities are charged to the third green pixel G3, therefore the charge ratio of the third green pixel G3 is comparatively low.

The pre-charge period PC of the third red pixel charge period R3C and the main-charge period PC of the third green pixel charge period G3C are overlapped. The negative red signal R− is charged to the third red pixel R3 during the pre-charge period PC of the third red pixel charge period R3C corresponding to the negative green signal G− charged to the third green pixel G3 during the main-charge period MC of the third green pixel charge period G3C. The negative red signal R− is charged to the third red pixel R3 during the main-charge period MC of the third red pixel charge period R3C. The negative red signals R− having substantially the same polarities are charged to the third red pixel R3, therefore the charge ratio of the third red pixel R3 is comparatively high.

FIG. 6B is a waveform diagram illustrating the blue data signal, the red data signal, the blue data signal, and the red data signal respectively charged to the first blue pixel B1, the second red pixel R2, the third blue pixel B3, and the fourth red pixel R4 of FIG. 2 during the (N+1)-th frame.

Referring to FIGS. 2, 3B, 4B, and 6B, the pre-charge period PC of the first blue pixel charge period B1C and the main-charge period PC of the fourth red pixel charge period R4C are overlapped. The positive blue signal B+ is charged to the first blue pixel B1 during the pre-charge period PC of the first blue pixel charge period B1C corresponding to the positive red signal R+ charged to the fourth red pixel R4 during the main-charge period MC of the fourth red pixel charge period R4C. The negative blue signal B− is charged to the first blue pixel B1 during the main-charge period MC of the first blue pixel charge period B1C. The positive blue signal B+ and the negative blue signal B− having different polarities are charged to the first blue pixel B1, therefore the charge ratio of the first blue pixel B1 is comparatively low.

The pre-charge period PC of the second red pixel charge period R2C and the main-charge period PC of the first blue pixel charge period B1C are overlapped. The negative red signal R− is charged to the second red pixel R2 during the pre-charge period PC of the second red pixel charge period R2C corresponding to the negative blue signal B− charged to the first blue pixel B1 during the main-charge period MC of the first blue pixel charge period B1C. The negative red signal R− is charged to the second red pixel R2 during the main-charge period MC of the second red pixel charge period R2C. The negative red signals R− having substantially the same polarities are charged to the second red pixel R2, therefore the charge ratio of the second red pixel R2 is comparatively high.

The pre-charge period PC of the third blue pixel charge period B3C and the main-charge period PC of the second red pixel charge period R2C are overlapped. The negative blue signal B− is charged to the third blue pixel B3 during the pre-charge period PC of the third blue pixel charge period B3C corresponding to the negative red signal R− charged to the second red pixel R2 during the main-charge period MC of the second red pixel charge period R2C. The positive blue signal B+ is charged to the third blue pixel B3 during the main-charge period MC of the third blue pixel charge period B3C. The negative blue signal B− and the positive blue signal B+ having different polarities are charged to the third blue pixel B3, therefore the charge ratio of the third blue pixel B3 is comparatively low.

The pre-charge period PC of the fourth red pixel charge period R4C and the main-charge period PC of the third blue pixel charge period B3C are overlapped. The positive red signal R+ is charged to the fourth red pixel R4 during the pre-charge period PC of the fourth red pixel charge period R4C corresponding to the positive blue signal B+ charged to the third blue pixel B3 during the main-charge period MC of the third blue pixel charge period B3C. The positive red signal R+ is charged to the fourth red pixel R4 during the main-charge period MC of the fourth red pixel charge period R4C. The positive red signals R+ having substantially the same polarities are charged to the fourth red pixel R4, therefore the charge ratio of the fourth red pixel R4 is comparatively high.

FIG. 6C is a waveform diagram illustrating the green data signal, the blue data signal, the green data signal, and the blue data signal respectively charged to the second green pixel G2, the second blue pixel B2, the fourth green pixel G4, and the fourth blue pixel B4 of FIG. 2 during the (N+1)-th frame.

Referring to FIGS. 2, 3B, 4B, and 6C, the pre-charge period PC of the second green pixel charge period G2C and the main-charge period PC of the fourth blue pixel charge period B4C are overlapped. The negative green signal G− is charged to the second green pixel G2 during the pre-charge period PC of the second green pixel charge period G2C corresponding to the negative blue signal B− charged to the fourth blue pixel B4 during the main-charge period MC of the fourth blue pixel charge period B4C. The positive green signal G+ is charged to the second green pixel G2 during the main-charge period MC of the second green pixel charge period G2C. The negative green signal G− and the positive green signal G+ having different polarities are charged to the second green pixel G2, therefore the charge ratio of the second green pixel G2 is comparatively low.

The pre-charge period PC of the second blue pixel charge period B2C and the main-charge period PC of the second green pixel charge period G2C are overlapped. The positive blue signal B+ is charged to the second blue pixel B2 during the pre-charge period PC of the second blue pixel charge period B2C corresponding to the positive green signal G+ charged to the second green pixel G2 during the main-charge period MC of the second green pixel charge period G2C. The positive blue signal B+ is charged to the second blue pixel B2 during the main-charge period MC of the second blue pixel charge period B2C. The positive blue signals B+ having substantially the same polarities are charged to the second blue pixel B2, therefore the charge ratio of the second blue pixel B2 is comparatively high.

The pre-charge period PC of the fourth green pixel charge period G4C and the main-charge period PC of the second blue pixel charge period B2C are overlapped. The positive green signal G+ is charged to the fourth green pixel G4 during the pre-charge period PC of the fourth green pixel charge period G4C corresponding to the positive blue signal B+ charged to the second blue pixel B2 during the main-charge period MC of the second blue pixel charge period B2C. The negative green signal G− is charged to the fourth green pixel G4 during the main-charge period MC of the fourth green pixel charge period G4C. The positive green signal G+ and the negative green signal G− having different polarities are charged to the fourth green pixel G4, therefore the charge ratio of the fourth green pixel G4 is comparatively low.

The pre-charge period PC of the fourth blue pixel charge period B4C and the main-charge period PC of the fourth green pixel charge period G4C are overlapped. The negative blue signal B− is charged to the fourth blue pixel B4 during the pre-charge period PC of the fourth blue pixel charge period B4C corresponding to the negative green signal G− charged to the fourth green pixel G4 during the main-charge period MC of the fourth green pixel charge period G4C. The negative blue signal B− is charged to the fourth blue pixel B4 during the main-charge period MC of the fourth blue pixel charge period B4C. The negative blue signals B− having substantially the same polarities are charged to the fourth blue pixel B4, therefore the charge ratio of the fourth blue pixel B4 is comparatively high.

During the N-th frame, the charge ratio of the first red pixel R1 is comparatively low, the charge ratio of the first green pixel G1 is comparatively high, the charge ratio of the third red pixel R3 is comparatively low, and the charge ratio of the third green pixel G3 is comparatively high. The charge ratio of the second red pixel R2 is comparatively low, the charge ratio of the first blue pixel B1 is comparatively high, the charge ratio of the fourth red pixel R4 is comparatively low, and the charge ratio of the third blue pixel B3 is comparatively high. Additionally, the charge ratio of the second blue pixel B2 is comparatively low, the charge ratio of the second green pixel G2 is comparatively high, the charge ratio of the fourth blue pixel B4 is comparatively low, and the charge ratio of the fourth green pixel G4 is comparatively high.

During the (N+1)-th frame, on the other hand, the charge ratio of the first red pixel R1 is comparatively high, the charge ratio of the first green pixel G1 is comparatively low, the charge ratio of the third red pixel R3 is comparatively high, and the charge ratio of the third green pixel G3 is comparatively low. The charge ratio of the second red pixel R2 is comparatively high, the charge ratio of the first blue pixel B1 is comparatively low, the charge ratio of the fourth red pixel R4 is comparatively high, and the charge ratio of the third blue pixel B3 is comparatively low. Additionally, the charge ratio of the second blue pixel B2 is comparatively high, the charge ratio of the second green pixel G2 is comparatively low, the charge ratio of the fourth blue pixel B4 is comparatively high, and the charge ratio of the fourth green pixel G4 is comparatively low.

Thus, the charge ratios of the first red pixel R1, the first green pixel G1, the first blue pixel B1, the second red pixel R2, the second green pixel G2, the second blue pixel B2, the third red pixel R3, the third green pixel G3, the third blue pixel B3, the fourth red pixel R4, the fourth green pixel G4, and the fourth blue pixel B4 during the N-th frame and the (N+1)-th frame, may be substantially the same.

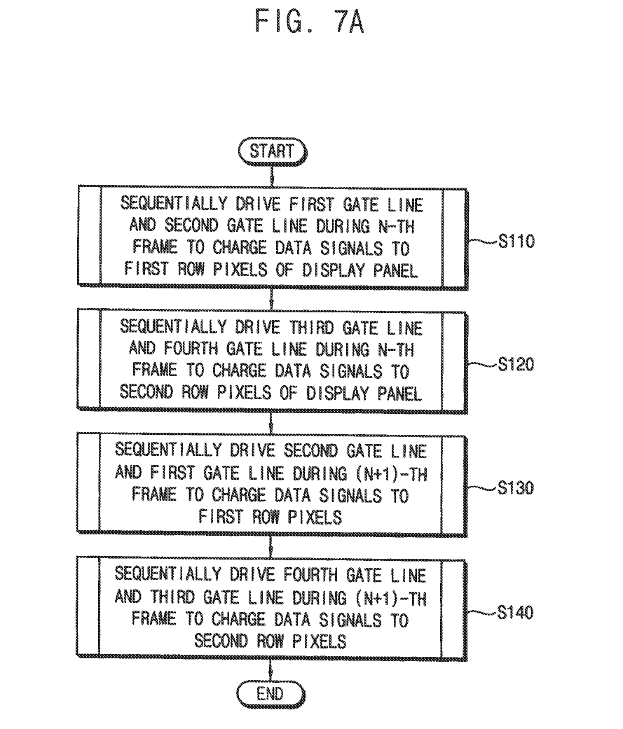

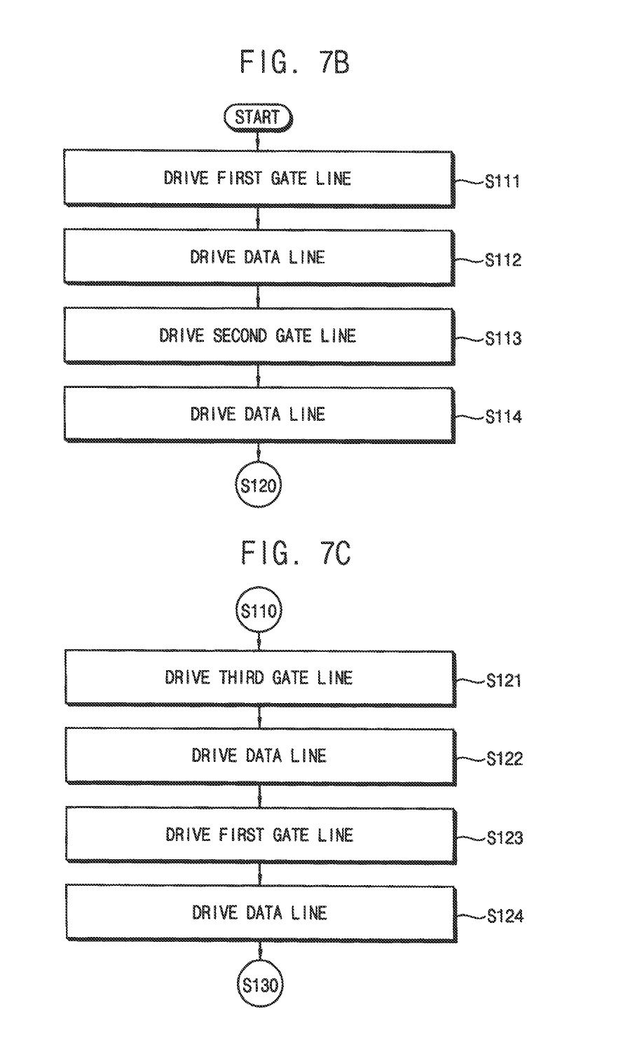

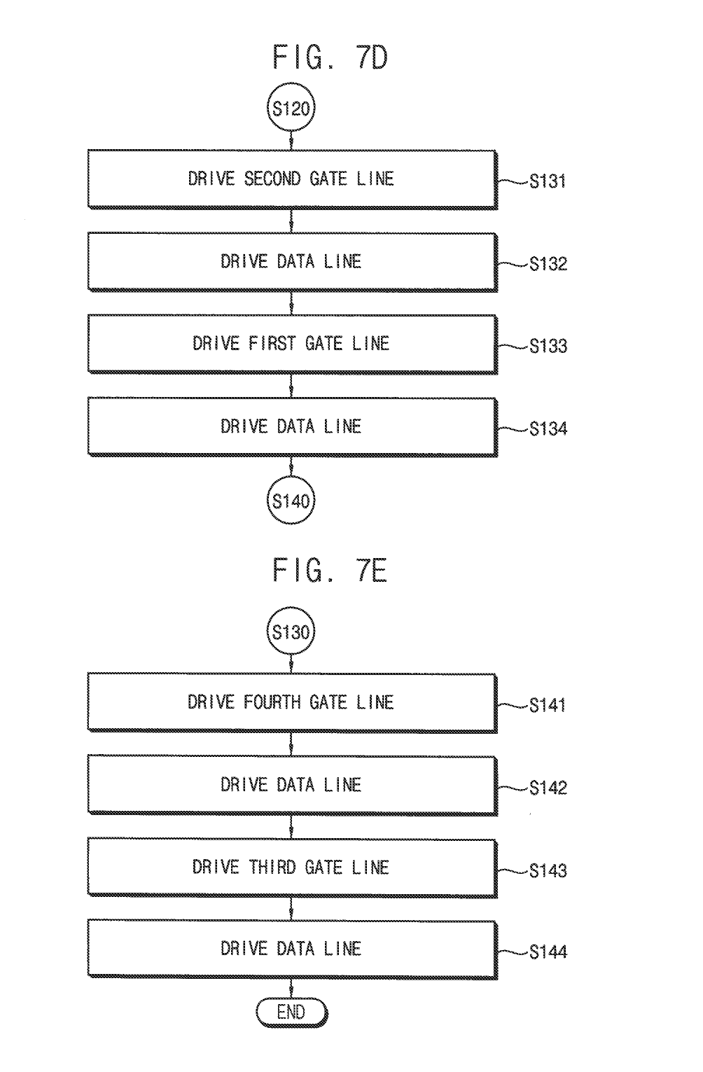

FIGS. 7A, 7B, 7C, 7D and 7E are flow charts illustrating an exemplary embodiment of a method of driving the display panel driving apparatus of FIG. 1.

Referring to FIGS. 1, 2, 3A, 3B, 7A, 7B, 7C, 7D and 7E, the first gate line GL1 and the second gate line GL2 are sequentially driven during the N-th frame to charge the data signals to the first row pixels of the display panel 110 (operation S110).

Specifically, during sequentially driving first gate line and second gate line during N-th frame to charge data signals to first row pixels of display panel (operation S110), the first gate line GL1 is driven (operation S111), as shown in FIG. 7B. The timing controlling part 150 outputs the first gate clock signal CLK1 to the gate driving part 130. The gate driving part 130 outputs the gate signal GS to the first gate line GL1 in response to the first gate clock signal CLK1. The data line DL is driven (operation S112). The data driving part 140 outputs the data signals DS to the data lines DL. Thus, the red data signal is charged to the first red pixel R1, the red data signal is charged to the second red pixel R2, and the blue data signal is charged to the second blue pixel B2. The second gate line GL2 is driven (operation S113). The timing controlling part 150 outputs the second gate clock signal CLK2 to the gate driving part 130. The gate driving part 130 outputs the gate signal GS to the second gate line GL2 in response to the second gate clock signal CLK2. The data line DL is driven (operation S114). The data driving part 140 outputs the data signals DS to the data lines DL. Thus, the green data signal is charged to the first green pixel G1, the blue data signal is charged to the first blue pixel B1, and the green data signal is charged to the second green pixel G2.

Referring back to FIG. 7A, third gate line GL3 and the fourth gate line GL4 are sequentially driven during the N-th frame to charge the data signals to the second row pixels of the display panel 110 (operation S120).

Specifically, during sequentially driving third gate line and fourth gate line during N-th frame to charge data signals to second row pixels of display panel (operation S120), the third gate line GL3 is driven (operation S121), as shown in FIG. 7C. The timing controlling part 150 outputs the first gate clock signal CLK1 to the gate driving part 130. The gate driving part 130 outputs the gate signal GS to the third gate line GL3 in response to the first gate clock signal CLK1. The data line DL is driven (operation S122). The data driving part 140 outputs the data signals DS to the data lines DL. Thus, the red data signal is charged to the third red pixel R3, the red data signal is charged to the fourth red pixel R4, and the blue data signal is charged to the fourth blue pixel B4. The fourth gate line GL4 is driven (operation S123). The timing controlling part 150 outputs the second gate clock signal CLK2 to the gate driving part 130. The gate driving part 130 outputs the gate signal GS to the fourth gate line GL4 in response to the second gate clock signal CLK2. The data line DL is driven (operation S124). The data driving part 140 outputs the data signals DS to the data lines DL. Thus, the green data signal is charged to the third green pixel G3, the blue data signal is charged to the third blue pixel B3, and the green data signal is charged to the fourth green pixel G4.

The second gate line GL2 and the first gate line GL1 are sequentially driven during the (N+1)-th frame to charge the data signals to the first row pixels of the display panel 110 (operation S130).

Specifically, during sequentially driving second gate line and first gate line during (N+1)-th frame to charge data signals to first row pixels (operation S130), the second gate line GL2 is driven (step S131). The timing controlling part 150 outputs the second gate clock signal CLK2 to the gate driving part 130. The gate driving part 130 outputs the gate signal GS to the second gate line GL2 in response to the second gate clock signal CLK2. The data line DL is driven (operation S132). The data driving part 140 outputs the data signals DS to the data lines DL. Thus, the green data signal is charged to the first green pixel G1, the blue data signal is charged to the first blue pixel B1, and the green data signal is charged to the second green pixel G2. The first gate line GL1 is driven (operation S133). The timing controlling part 150 outputs the first gate clock signal CLK1 to the gate driving part 130. The gate driving part 130 outputs the gate signal GS to the first gate line GL1 in response to the first gate clock signal CLK1. The data line DL is driven (operation S134). The data driving part 140 outputs the data signals DS to the data lines DL. Thus, the red data signal is charged to the first red pixel R1, the red data signal is charged to the second red pixel R2, and the blue data signal is charged to the second blue pixel B2.

The fourth gate line GL4 and the third gate line GL3 are sequentially driven during the (N+1)-th frame to charge the data signals to the second row pixels of the display panel 110 (operation S140).

Specifically, during sequentially driving fourth gate line and third gate line during (N+1)-th frame to charge data signals to second row pixels (operation S140), the fourth gate line GL4 is driven (operation S141). The timing controlling part 150 outputs the second gate clock signal CLK2 to the gate driving part 130. The gate driving part 130 outputs the gate signal GS to the fourth gate line GL4 in response to the second gate clock signal CLK2. The data line DL is driven (operation S142). The data driving part 140 outputs the data signals DS to the data lines DL. Thus, the green data signal is charged to the third green pixel G3, the green data signal is charged to the third blue pixel B3, and the green data signal is charged to the fourth green pixel G4. The third gate line GL3 is driven (operation S143). The timing controlling part 150 outputs the first gate clock signal CLK1 to the gate driving part 130. The gate driving part 130 outputs the gate signal GS to the third gate line GL3 in response to the first gate clock signal CLK1. The data line DL is driven (operation S144). The data driving part 140 outputs the data signals DS to the data lines DL. Thus, the red data signal is charged to the third red pixel R3, the red data signal is charged to the fourth red pixel R4, and the blue data signal is charged to the fourth blue pixel B4.

According to the present exemplary embodiment, the charge ratios of the first red pixel R1, the first green pixel G1, the first blue pixel B1, the second red pixel R2, the second green pixel G2, the second blue pixel B2, the third red pixel R3, the third green pixel G3, the third blue pixel B3, the fourth red pixel R4, the fourth green pixel G4, and the fourth blue pixel B4 during the N-th frame and the (N+1)-th frame, are substantially the same, therefore charge ratios of the pixels 120 included in the display panel 110 are uniform and the pixels 120 may display a white color. Thus, display quality of the display apparatus 100 may be improved.

In exemplary embodiments, the gate driving part 130, the data driving part 140, the timing controlling part 150, and/or one or more components thereof, may be implemented via one or more general purpose and/or special purpose components, such as one or more discrete circuits, digital signal processing chips, integrated circuits, application specific integrated circuits, microprocessors, processors, programmable arrays, field programmable arrays, instruction set processors, and/or the like.

According to exemplary embodiments, the features, functions, and/or processes described herein may be implemented via software, hardware (e.g., general processor, digital signal processing (DSP) chip, an application specific integrated circuit (ASIC), field programmable gate arrays (FPGAs), etc.), firmware, or a combination thereof. In this manner, the gate driving part 130, the data driving part 140, the timing controlling part 150, and/or one or more components thereof may include or otherwise be associated with one or more memories (not shown) including code (e.g., instructions) configured to cause the gate driving part 130, the data driving part 140, the timing controlling part 150, and/or one or more components thereof to perform one or more of the features, functions, and/or processes described herein.

The memories may be any medium that participates in providing code/instructions to the one or more software, hardware, and/or firmware components for execution. Such memories may take many forms, including but not limited to non-volatile media, volatile media, and transmission media. Non-volatile media include, for example, optical or magnetic disks. Volatile media include dynamic memory. Transmission media include coaxial cables, copper wire and fiber optics. Transmission media can also take the form of acoustic, optical, or electromagnetic waves. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, or any other medium from which a computer can read.

According to the method of driving a display panel, the display panel driving apparatus and the display apparatus having the display panel driving apparatus, charge ratios of pixels are uniform or substantially uniform, and therefore display quality of the display apparatus may be improved.

The foregoing is illustrative of the present inventive concept and is not to be construed as limiting thereof. Although a few exemplary embodiments of the present inventive concept have been described, those skilled in the art will readily appreciate that many modifications are possible in the exemplary embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific exemplary embodiments disclosed, and that modifications to the disclosed exemplary embodiments, as well as other exemplary embodiments, are intended to be included within the scope of the appended claims. The present inventive concept is defined by the following claims, with equivalents of the claims to be included therein.

What is claimed is:

1. A method of driving a display panel, the method comprising:
sequentially driving a first gate line and a second gate line of a display panel during an N-th frame to charge data signals to first row pixels electrically connected to the first gate line and the second gate line;
sequentially driving a third gate line and a fourth gate line of the display panel during the N-th frame to charge the data signals to second row pixels electrically connected to the third gate line and the fourth gate line;
sequentially driving the second gate line and the first gate line during an (N+1)-th frame next to the N-th frame to charge the data signals to the first row pixels; and
sequentially driving the fourth gate line and the third gate line during the (N+1)-th frame to charge the data signals to the second row pixels.

2. The method of claim 1, wherein data signals having different polarities are applied to adjacent data lines.

3. The method of claim 2, wherein polarities of the data signals are inverted every two horizontal periods.

4. The method of claim 1, wherein the sequentially driving the first gate line and the second gate line during the N-th frame comprises:
driving the first gate line;
driving data lines to charge the data signals to the first row pixels connected to the first gate line;
driving the second gate line; and
driving the data lines to charge the data signals to the first row pixels connected to the second gate line.

5. The method of claim 4, wherein the sequentially driving the third gate line and the fourth gate line during the N-th frame comprises:
driving the third gate line;
driving the data lines to charge the data signals to the second pixels connected to the third gate line;
driving the fourth gate line; and
driving the data lines to charge the data signals to the second pixels connected to the fourth gate line.

6. The method of claim 5, wherein the sequentially driving the second gate line and the first gate line during the (N+1)-th frame comprises:
driving the second gate line;
driving the data lines to charge the data signals to the first row pixels connected to the second gate line;
driving the first gate line; and
driving the data lines to charge the data signals to the first row pixels connected to the first gate line.

7. The method of claim 6, wherein the sequentially driving the fourth gate line and the third gate line during the (N+1)-th frame comprises:
driving the fourth gate line;
driving the data lines to charge the data signals to the second pixels connected to the fourth gate line;
driving the third gate line; and
driving the data lines to charge the data signals to the second pixels connected to the third gate line.

8. The method of claim 1, wherein the first row pixels comprises:
a first red pixel electrically connected to the first gate line and a first data line;
a first green pixel electrically connected to the second gate line and the first data line;
a first blue pixel electrically connected to the second gate line and a second data line;
a second red pixel electrically connected to the first gate line and the second data line;
a second green pixel electrically connected to the second gate line and a third data line; and
a second blue pixel electrically connected to the first gate line and the third data line.

9. The method of claim 8, wherein the second row pixels comprises:
a third red pixel electrically connected to the third gate line and the first data line;
a third green pixel electrically connected to the fourth gate line and the first data line;
a third blue pixel electrically connected to the fourth gate line and the second data line;
a fourth red pixel electrically connected to the third gate line and the second data line;
a fourth green pixel electrically connected to the fourth gate line and the third data line; and
a fourth blue pixel electrically connected to the third gate line and the third data line.

10. The method of claim 9, wherein:
the first red pixel, the first green pixel, the third red pixel and the third green pixel are sequentially charged during the N-th frame;
the second red pixel, the first blue pixel, the fourth red pixel and the third blue pixel are sequentially charged during the N-th frame; and
the second blue pixel, the second green pixel, the fourth blue pixel and the fourth green pixel are sequentially charged during the N-th frame.

11. The method of claim 10, wherein:
the first red pixel is charged during a first red pixel charge period;
the first green pixel is charged during a first green pixel charge period;
the third red pixel is charged during a third red pixel charge period;
the third green pixel is charged during a third green pixel charge period;
the second red pixel is charged during a second red pixel charge period;
the first blue pixel is charged during a first blue pixel charge period;
the fourth red pixel is charged during a fourth red pixel charge period;
the third blue pixel is charged during a third blue pixel charge period;
the second blue pixel is charged during a second blue pixel charge period;
the second green pixel is charged during a second green pixel charge period;
the fourth blue pixel is charged during a fourth blue pixel charge period;
the fourth green pixel is charged during a fourth green pixel charge period; and
each of the first red pixel charge period, the first green pixel charge period, the third red pixel charge period, the third green pixel charge period, the second red pixel charge period, the first blue pixel charge period, the fourth red pixel charge period, the third blue pixel charge period, the second blue pixel charge period, the second green pixel charge period, the fourth blue pixel charge period, and the fourth green pixel charge period comprises a pre-charge period and a main-charge period.

12. The method of claim 11, wherein:
the pre-charge period of the first green pixel charge period overlap the main-charge period of the first red pixel charge period;
the pre-charge period of the third red pixel charge period overlap the main-charge period of the first green pixel charge period;
the pre-charge period of the third green pixel charge period overlap the main-charge period of the third red pixel charge period;
the pre-charge period of the first red pixel charge period overlap the main-charge period of the third green pixel charge period;
the pre-charge period of the first blue pixel charge period overlap the main-charge period of the second red pixel charge period;
the pre-charge period of the fourth red pixel charge period overlap the main-charge period of the first blue pixel charge period;
the pre-charge period of the third blue pixel charge period overlap the main-charge period of the fourth red pixel charge period;
the pre-charge period of the second red pixel charge period overlap the main-charge period of the third blue pixel charge period;
the pre-charge period of the second green pixel charge period overlap the main-charge period of the second blue pixel charge period;
the pre-charge period of the fourth blue pixel charge period overlap the main-charge period of the second green pixel charge period;
the pre-charge period of the fourth green pixel charge period overlap the main-charge period of the fourth blue pixel charge period; and
the pre-charge period of the second blue pixel charge period overlap the main-charge period of the fourth green pixel charge period.

13. The method of claim 12, wherein:
the first red pixel, the first red pixel, the third green pixel and the third red pixel are sequentially charged during the (N+1)-th frame;
the first blue pixel, the second red pixel, the third blue pixel and the fourth red pixel are sequentially charged during the (N+1)-th frame; and
the second green pixel, the second blue pixel, the fourth green pixel and the fourth blue pixel are sequentially charged during the (N+1)-th frame.

14. The method of claim 13, wherein:
the pre-charge period of the first red pixel charge period overlap the main-charge period of the first green pixel charge period;
the pre-charge period of the third green pixel charge period overlap the main-charge period of the first red pixel charge period;
the pre-charge period of the third red pixel charge period overlap the main-charge period of the third green pixel charge period;
the pre-charge period of the first green pixel charge period overlap the main-charge period of the third red pixel charge period;
the pre-charge period of the second red pixel charge period overlap the main-charge period of the first blue pixel charge period;
the pre-charge period of the third blue pixel charge period overlap the main-charge period of the second red pixel charge period;
the pre-charge period of the fourth red pixel charge period overlap the main-charge period of the third blue pixel charge period;
the pre-charge period of the first blue pixel charge period overlap the main-charge period of the fourth red pixel charge period;
the pre-charge period of the second blue pixel charge period overlap the main-charge period of the second green pixel charge period;
the pre-charge period of the fourth green pixel charge period overlap the main-charge period of the second blue pixel charge period;
the pre-charge period of the fourth blue pixel charge period overlap the main-charge period of the fourth green pixel charge period; and
the pre-charge period of the second green pixel charge period overlap the main-charge period of the fourth blue pixel charge period.

15. The method of claim 1, wherein:
the sequentially driving the first gate line and the second gate line during the N-th frame comprises sequentially outputting a first gate clock signal and a second gate clock signal during the N-th frame;
sequentially driving the third gate line and the fourth gate line during the N-th frame comprises sequentially outputting the first gate clock signal and the second gate clock signal during the N-th frame;
sequentially driving the second gate line and the first gate line during the (N+1)-th frame comprises sequentially outputting the second gate clock signal and the first gate clock signal during the (N+1)-th frame; and
sequentially driving the fourth gate line and the third gate line during the (N+1)-th frame comprises sequentially outputting the second gate clock signal and the first gate clock signal during the (N+1)-th frame.

16. A display panel driving apparatus comprising:
a gate driver configured to sequentially drive a first gate line and a second gate line of a display panel during an N-th frame, configured to sequentially drive a third gate line and a fourth gate line of the display panel during the N-th frame, configured to sequentially drive the second gate line and the first gate line during an (N+1)-th frame next to the N-th frame, and configured to drive the fourth gate line and the third gate line during the (N+1)-th frame; and
a data driver configured to charge data signals to first row pixels electrically connected to the first gate line and the second gate line during the N-th frame, configured to charge the data signals to second row pixels electrically connected to the third gate line and the fourth gate line, configured to charge the data signals to the first row pixels during the (N+1)-th frame, and configured to charge the data signals to the second row pixels during the (N+1)-th frame.

17. The display panel driving apparatus of claim 16, further comprising:
a timing controller configured to sequentially output a first gate clock signal and a second gate clock signal to the gate driver during the N-th frame and sequentially output the second gate clock signal and the first gate clock signal to the gate driver during the (N+1)-th frame.

18. The display panel driving apparatus of claim 16, wherein the first row pixels comprises:
a first red pixel electrically connected to the first gate line and a first data line;
a first green pixel electrically connected to the second gate line and the first data line;
a first blue pixel electrically connected to the second gate line and a second data line;
a second red pixel electrically connected to the first gate line and the second data line;
a second green pixel electrically connected to the second gate line and a third data line; and
a second blue pixel electrically connected to the first gate line and the third data line.

19. The display panel driving apparatus of claim 18, wherein the second row pixels comprises:
a third red pixel electrically connected to the third gate line and the first data line;
a third green pixel electrically connected to the fourth gate line and the first data line;
a third blue pixel electrically connected to the fourth gate line and the second data line;
a fourth red pixel electrically connected to the third gate line and the second data line;
a fourth green pixel electrically connected to the fourth gate line and the third data line; and
a fourth blue pixel electrically connected to the third gate line and the third data line.

20. A display apparatus comprising:
a display panel configured to display an image; and.
a display panel driving apparatus comprising:
a gate driver configured to sequentially drive a first gate line and a second gate line of the display panel during an N-th frame, configured to sequentially drive a third gate line and a fourth gate line of the display panel during the N-th frame, configured to sequentially drive the second gate line and the first gate line during an (N+1)-th frame next to the N-th frame and configured to drive the fourth gate line and the third gate line during the (N+1)-th frame; and
a data driver configured to charge data signals to first row pixels electrically connected to the first gate line and the second gate line during the N-th frame, configured to charge the data signals to second row pixels electrically connected to the third gate line and the fourth gate line, configured to charge the data signals to the first row pixels during the (N+1)-th frame and configured to charge the data signals to the second row pixels during the (N+1)-th frame.
